(19) United States
(12) Patent Application Publication
(10) Pub. No.: US 2008/0037806 A1
(43) Pub. Date: Feb. 14, 2008

(54) PREAMPLIFIER FOR MUSICAL INSTRUMENTS

(76) Inventor: Leslie M. Schatten, Kitchener (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, US

(21) Appl. No.: 11/837,905

(22) Filed: Aug. 13, 2007

Related U.S. Application Data
(60) Provisional application No. 60/822,270, filed on Aug. 14, 2006.

(51) Int. Cl. G10H 1/00

(52) U.S. Cl. 381/118

(57) ABSTRACT

The invention is directed at a preamplifier for a musical instrument comprising apparatus for receiving and processing a signal from a sound gathering device and for transmitting the processed signal to an external apparatus; an internal power source; a voltage receiving circuit, for receiving power from the external apparatus; and a voltage determining circuit, connected to the internal power source and the voltage receiving circuit, for determining whether the internal power source or the voltage receiving circuit should power the preamplifier by determining which is providing a higher voltage.

### CROSS REFERENCE TO RELATED APPLICATIONS

This application claims the benefit of priority of U.S. Provisional Patent Application No. 60/822,270 filed Aug. 14, 2006, which is incorporated herein by reference.

### FIELD OF THE INVENTION

The present invention relates generally to musical instruments. More particularly, the present invention relates to a preamplifier for musical instruments.

### BACKGROUND OF THE INVENTION

In the music industry, preamplifiers are typically built into a musical instrument, such as a violin of a guitar, or are an external part which can be connected to the instrument. A preamplifier is typically used to alter, process or prepare electronic signals, produced by the instrument, for transmission to a power amplifier or public address (P.A.) system. The signals are transmitted to the preamplifier via a sound gathering device such as a transducer, a magnetic device, a piezo-electric device or a microphone or a combination thereof. Once the signal is received, the preamplifier processes the signal and transmits it to the power amplifier or P.A. system. In order to alter the signals, the preamplifier requires a voltage in order to operate.

Preamplifiers are typically powered in a variety of manners. A first method is when the preamplifier is housed within, or attached to, the musical instrument and is powered by a battery power source located within, or attached to, the musical instrument. This is the most common method of powering the preamplifier. A second method is when the preamplifier is housed within the musical instrument and powered by a battery power source within the musical instrument or powered by a power adapter located external to the instrument. In a further method, the preamplifier is a stand alone product and powered by an external power source.

However, in each of these powering methods, the selection of the powering method is determined by a user or musician. In other words, the powering of the preamplifier must be switched by the user from one powering source to another through the use of a physical switch.

It is, therefore, desirable to provide a novel preamplifier for a musical instrument.

### SUMMARY OF THE INVENTION

It is an object of the present invention to obviate or mitigate at least one disadvantage of previous preamplifiers for musical instruments.

In a first aspect, the present invention provides a preamplifier for a musical instrument comprising apparatus for receiving and processing a signal from a sound gathering device and for transmitting the processed signal to an external apparatus; an internal power source; a voltage receiving circuit, for receiving power from the external apparatus; and a voltage determining circuit, connected to the internal power source and the voltage receiving circuit, for determining whether the internal power source or the voltage receiving circuit should power the preamplifier by determining which is providing a higher voltage.

In a further embodiment, there is provided a method of automatically determining which, of a plurality of power sources, to use for powering a preamplifier comprising receiving an input voltage from an external power source; regulating the input voltage to produce a predetermined voltage; comparing the predetermined voltage with an internal power source voltage; and powering the preamplifier with the higher voltage.

In a further aspect, the present invention provides a preamplifier for use with a multi-pin conductor cable having a ¼″ stereo plug, the conductor cable connected to an external apparatus at an opposite end, comprising an input buffer, for receiving input from at least one sound gathering device; a mixer amplifier, for mixing signals from the input buffer, for transmission to the external apparatus; a jack for receiving the stereo plug of the multi-pin cable; and a voltage circuit for transmitting signals to the multi-pin cable regardless of the pin settings.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic diagram of a musical system including a preamplifier;

FIG. 2 is a schematic view of the preamplifier; and

FIG. 3 is a detailed schematic of an embodiment of the preamplifier.

### DETAILED DESCRIPTION

Generally, the present invention provides a method and apparatus for a preamplifier for a musical instrument such as, but not limited to, a violin, a guitar or a double bass. In some cases, since power can be supplied to the preamplifier from a plurality of sources, the preamplifier includes a voltage determining circuit which allows the preamplifier to automatically determine where power is to be drawn.

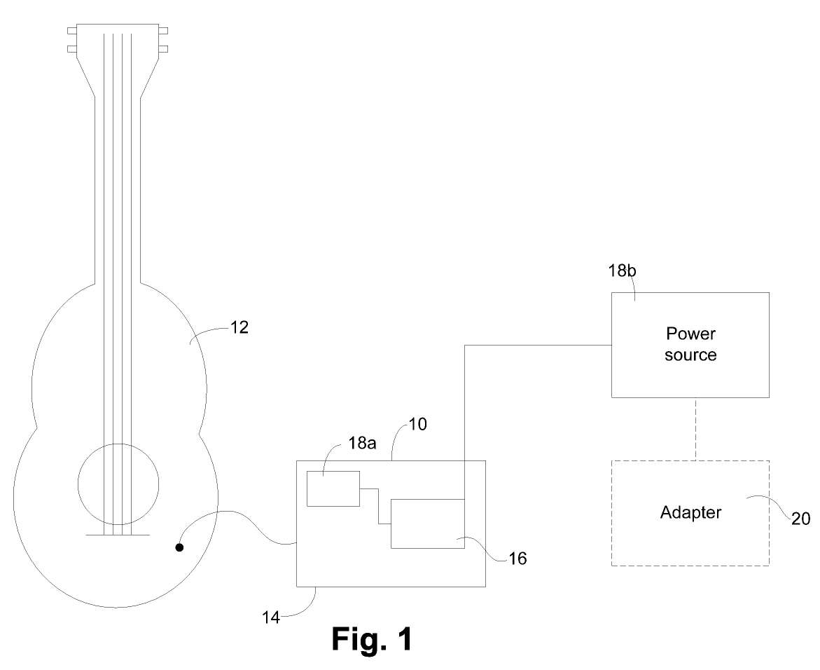

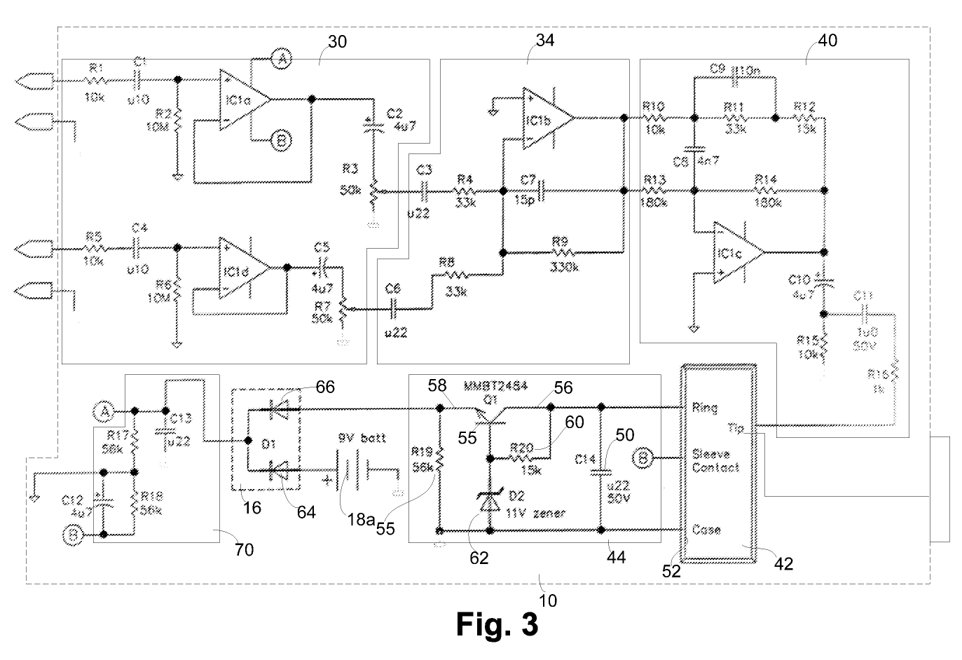

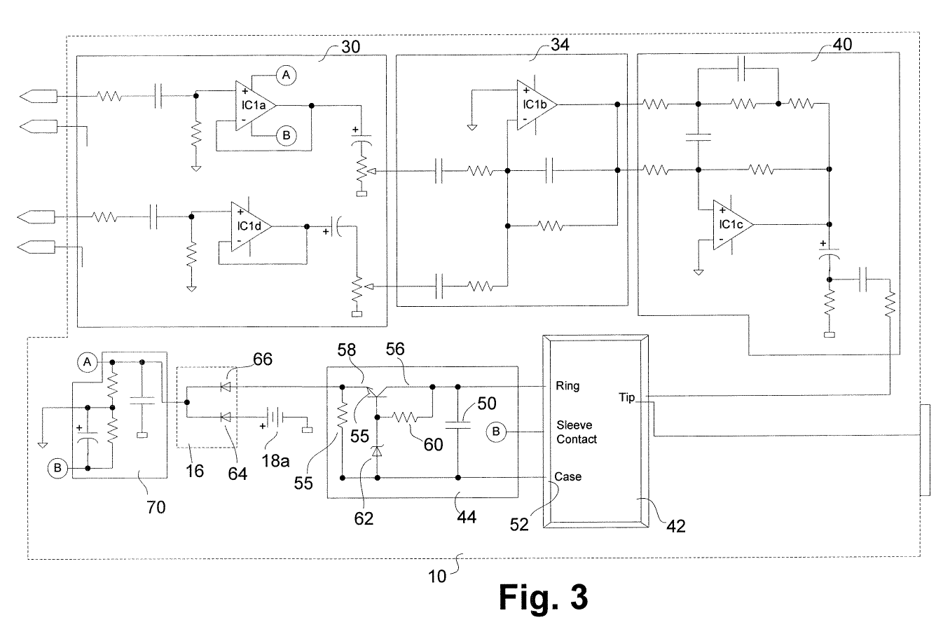

Turning to FIG. 1, a schematic diagram of a preamplifier within a musical system is shown. A preamplifier is an apparatus which prepares an electronic signal, from an instrument, for further amplification or processing. The preamplifier 10, which is connected to a musical instrument, such as guitar 12, includes a housing 14 for housing hardware which performs the function described above. This hardware will be more clearly seen and described with respect to FIG. 3. The preamplifier 10 further includes an electronic voltage determining apparatus, or circuit, 16 which can be located within the housing 14 or remote from the housing but in wired connection. In the present embodiment, the voltage determining apparatus 16 is located within the housing 14.

A plurality of power sources 18 are connected to the voltage determining apparatus 16, such as an internal power source 18a and an external power source 18b. In one embodiment, the internal power source 18a is a 9 V dc power source and the external power source 18b is a phantom power source from an external apparatus such as instrument amplifier, public address (p.a.) system, a p.a. mixer or a battery power source. If the external power source 18b is a battery power source, an AC to DC adapter 20 can be connected to the power source 18b to step down AC wall current so that the battery power source can provide a predetermined voltage to the preamplifier 10. As will be understood, other types of external power sources 18b can be connected to the preamplifier 10.

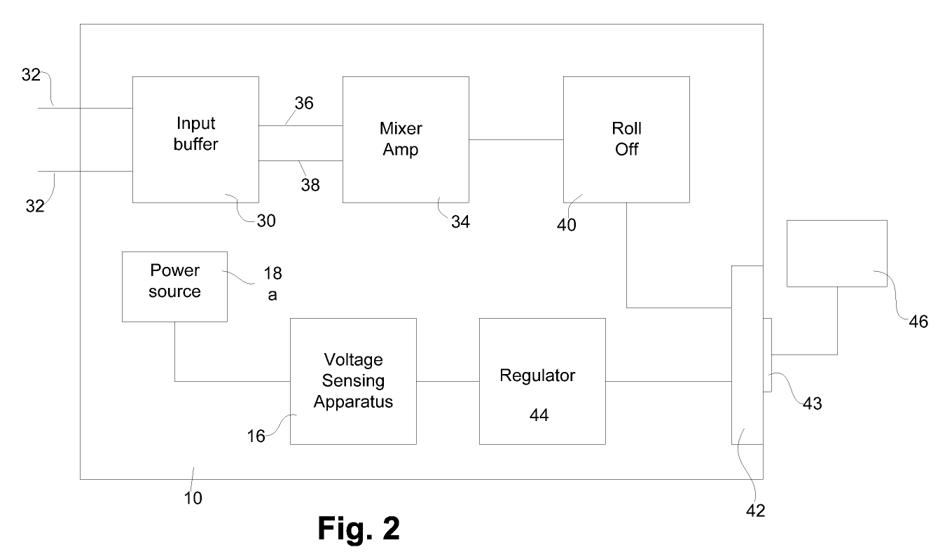

Turning to FIG. 2, a more detailed schematic of the preamplifier 10 is shown. The preamplifier 10 includes a set of input buffers 30 which is connected to at least one sound gathering device, such as a transducer, associated with a musical instrument, via input ports, or pins 32. In the preferred embodiment, the set of input buffers 30 includes two input buffers allowing for two sound gathering devices to be connected thereto. The individual input buffers are preferably high impedance amplifiers which restrict, or prevent, the preamplifier 10 from loading the pickup transducer and lowering or distorting the signal from the transducer.

Outputs 36 and 38 of the input buffers 30 are connected to a mixer amplifier 34 so that the signals transmitted by the transducers can be balanced by mixing and amplifying the outputs 36 and 38. This is part of the processing of the electronic signals produced and transmitted by the musical instrument, or instruments. In the present embodiment, the mixer amplifier 34 is a two input summing amplifier which includes apparatus for reducing the high frequency response of the mixer amplifier 34 to reduce the overall noise generated by the preamplifier 10. As will be understood, other types of mixer amplifier circuits can also be used without deviating from the scope the invention.

In order to reduce, or prevent, a high frequency noise signal, the preamplifier 10 includes a high frequency roll-off circuit 40 which includes a two-pole roll off filter. An output of the roll off circuit 40 is connected to a jack 42 which, in turn, is connected to a voltage receiving circuit, or regulator, 44. The jack 42 also includes one port for receiving a plug 43, typically a ¼″ plug having a multiple electrical contacts, at an end of a cable. The other end of the cable is attached to an external apparatus 46 such as a power amplifier or public address system. The plug 43 can be configured in a two-contact mono format with contacts known as Tip and Sleeve (TS) or in a three contact stereo format with contacts known as Tip, Ring and Sleeve (TRS). A two contact mono plug, also known as a TS connector, is one of the most common audio connectors used in the music industry. A three contact stereo plug is also a common connector and is known as a TRS connector.

The plug 43 and cable provides a connection between the preamplifier 10 and the external apparatus 46 so that the processed signal can be transmitted from the roll off circuit 40 to the external apparatus 46. The plug and cable can also provide power, from an external power source, to the preamplifier 10. Examples of external apparatus include, but are not limited to, a guitar, a bass, a musical instrument amplifier, a public address system, and powered or unpowered mixers. The plug 43 can be a mono plug, a stereo plug, an XLR plug or a multiple-pin plug.

The regulator 44 receives the power, or voltage, input from the external apparatus and is also connected to the voltage determining circuit 16 which determines which, of a plurality of power sources, to use for powering the preamplifier 10. The internal power source 18a is also connected to the voltage determining apparatus 16.

Turning to FIG. 3, a more detailed circuit diagram of one embodiment of the preamplifier 10 is shown. Operation of the input buffers 30, mixer amplifier 34 and roll-off circuit 40 will be understood by one skilled in the art. The regulator 44, or external power source receiving circuit, is connected to a port, or a jack output, such as the port which receives the ring portion of the plug 43 which is inserted into the jack 42. In an alternative embodiment, the regulator 44 can be connected to the portion of the jack 42 which receives the tip portion of the plug 43. In the present embodiment, the output from the ring portion is connected to a capacitor 50. The capacitor 50 is also connected to a second input/output port 52 of the jack 42 which serves as Ground. The jack output is also connected to a transistor 54, preferably a bipolar transistor, via the Collector 56 of the transistor 54. The Emitter 58 of the transistor 54 is connected to the voltage determining circuit 16 and to Ground via a resistor 59. The Base of the transistor 54 is connected to the collector 56, via a resistor 60, and to Ground 52 via a reversed zener diode 62.

The voltage determining circuit 16 includes a first diode 64 which is connected to the internal power source 18a and a second diode 66 which is connected to the Emitter 58 of the transistor 54. The voltage determining circuit 16 constantly monitors the voltage levels which are being transmitted from the internal power source 18a and the Emitter 58 and allows the higher voltage to pass through its designated diode 66 or 68 while shutting off the other diode so that the voltage or power to power the amplifier is automatically determined by the preamplifier and provided via a single source. As will be understood, during transitions between the voltage being supplied by the Emitter and the internal power source, both diodes can be operational, however, this is only during the transition period and for a short period of time.

The pair of diodes 66 and 68 operate in tandem to pass the higher of the two voltages between the internal power source and the Emitter output. Once the voltage determining circuit 16 determines which voltage is higher, the diode with the lower voltage becomes reverse biased and shuts off, thereby preventing the lower of the two voltages from supplying power to the preamplifier. Since a conducting diode has a relatively constant voltage drop across its terminals, the remainder of the preamplifier circuit (load) automatically rises to the higher of the two supplied voltages (less the voltage drop across the diode). This results in a ‘reverse polarity’ condition occurring across the terminals of the diode that is connected to the lower of the two supplied voltages which causes that diode to turn off. Therefore, the preamplifier is automatically powered by the higher of the internal power source 18a or the external power source 18b without the need for a physical switch.

In the preferred embodiment, the internal power source 18a is a 9V battery and the regulator 44 is designed to provide or regulate any input voltage to a constant output of 10 volts. In this manner, the regulator 44 is continuously providing a higher voltage to the voltage determining circuit 16 and therefore powers the preamplifier (as long as there is a voltage available from the plug 43). Therefore, the life of the internal power source 18a is preserved and only used when necessary as replacement of the internal power source 18a is both time consuming and a cumbersome process. However, when there is no voltage being supplied by the jack 42, and the preamplifier 10 is in use, the preamplifier 10 is powered solely by the internal power source 18a. This occurs when a mono plug is plugged into the jack 42 and therefore, there is no power input to the jack 42 as a mono plug does not include a separate connection to the ring portion of the jack 42

Furthermore, as operational amplifiers, such as those listed as IC1 in FIG. 3, require both positive and negative voltages to operate, a virtual ground circuit 70 is provided so that a second internal power source is not required.

In operation, when a plug 43, such as a ¼″ plug, is inserted into the jack 42, the preamplifier 10 exits a stand-by mode and enters an operational mode. As the input buffer 30, the mixer amplifier 34 and roll-off circuit 40 operate in known manners to process signals from the instrument, the internal power source 18a provides power to the preamplifier 10 in order to allow the preamplifier 10 to operate. Since there is no initial voltage provided by the emitter 58 of the transistor 54, the diode 66 allows the power from the internal power source 18a to pass through while shutting off the other diode 68 connected to the regulator 44. If no power is supplied from the plug 43 to the jack output, such as by the insertion of a mono plug, the preamplifier 10 continues to operate while being powered by the internal power source 18a until the plug 43 is removed from the jack 42.

Alternatively, if power is supplied to the jack output, such as by the insertion of a ¼″ stereo plug of an XLR to stereo multi conductor cable (which is connected to a phantom power source in the external apparatus 46) or any other external power source, the regulator 44 receives the voltage and passes the voltage through the regulator circuitry before transmitting the output to the voltage determining circuit 16. As discussed above, in the preferred embodiment, the regulator is designed to provide a predetermined voltage (10 V) which is higher than the voltage provided by the internal power source 18a. Therefore, once the voltage level of the output at the Emitter 58 surpasses the voltage level of the internal power source 18a, the diode 66 connected to the internal power source 18a shuts off and voltage is supplied to the preamplifier 10 via the diode 68 and the regulator 44. In this manner, the power source providing the power to the preamplifier is automatically determined and switched by the preamplifier 10 rather than having a user determine and physically switch the power source supplying the power. Once activated, the voltage determining circuit 16 continuously compares the two voltages until the plug 43 is removed from the jack 42.

Another advantage of the invention is that the preamplifier is able to process the necessary signals when a multiple pin conductor cable having a stereo plug is used. An example of a multiple pin conductor cable is an XLR to stereo plug. In the external apparatus with Phantom Power, two of the pins of the XLR plug deliver power and receive the processed signal simultaneously {i.e. it is a balanced input}. The preamplifier 10 receives power from whichever pin on the XLR plug/jack 42 that the ring portion is connected to and delivers a processed signal to the other XLR plug/jack pin via the tip connection. The capacitor 50 shunts any signal from the XLR plug/jack pin that is connected to the ring, thus transforming the circuit connection to an un-balanced configuration.

In the preferred embodiment, the preamplifier 10 is hardwired to receive power from the ring connection and to provide the processed signal to the tip. However, other circuit board layouts are also possible where this can be reversed so that the tip can receive the power and the ring portion can transmit the processed signal. In this alternative embodiment, it will be understood that the regulator 44 is connected to the tip portion and the output of the roll-off circuit 40 is connected to the ring portion.

The relationship of the connection of the tip portion of the jack to one of the two pins comprising pins 2 or 3 of the XLR plug and the ring portion to the other of the pin 3 or 2 pair is typically determined by the user or the manufacturer of the external interconnecting cable.

Therefore, the preamplifier of the invention modifies the function of the balanced input of the external apparatus, if present, in that both power and signal are simultaneously present at both inputs to the external apparatus. This preamplifier 10 draws power from one of the external apparatus inputs and delivers a processed signal to the other of the external apparatus inputs.

One advantage of the invention is that it provides an improved and convenient method of powering preamplifiers built into or used in conjunction with stringed musical instruments. In an alternative embodiment, the preamplifier can be used with any other form of musical instrument having an electronic signal requiring amplification or pre-amplification.

Another advantage of the invention is that it is more user friendly as the preamplifier requires less mechanical intervention and is more adaptable for use.

Yet a further advantage is that the preamplifier does not require an extensive modification to the musical instrument to install the jack 42.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A preamplifier for a musical instrument comprising:
apparatus for receiving and processing a signal from a sound gathering device and for transmitting the processed signal to an external apparatus;
an internal power source;
a voltage receiving circuit, for receiving power from the external apparatus; and
a voltage determining circuit, connected to the internal power source and the voltage receiving circuit, for determining whether the internal power source or the voltage receiving circuit should power the preamplifier by determining which is providing a higher voltage.

2. The preamplifier of claim 1 wherein the voltage receiving circuit is a regulator.

3. The preamplifier of claim 2 wherein the preamplifier includes a jack.

4. The preamplifier of claim 3 wherein the jack includes a single port for receiving a plug from the external apparatus.

5. The preamplifier of claim 4 wherein the single port receives a ¼″ plug.

6. The preamplifier of claim 2 wherein the regulator regulates the voltage from the external apparatus to be a predetermined voltage.

7. The preamplifier of claim 6 wherein the predetermined voltage is higher than the voltage provided by the internal power source.

8. The preamplifier of claim 1 wherein the voltage determining circuit comprises:
a first diode connected to an output of the internal power source; and
a second diode connected to an output of the voltage receiving circuit.

9. The preamplifier of claim 6 wherein the first diode turns off if the predetermined voltage is higher than the output of the internal power source.

10. The preamplifier of claim 6 wherein the second diode turns off if the output of the internal power source is higher than the output of the voltage receiving circuit.

11. The preamplifier of claim 1 wherein the internal power source is a battery.

12. The preamplifier of claim 1 wherein the external apparatus is one of a guitar, a bass, a musical instrument amplifier, a public address system, a powered mixer or an unpowered mixer.

13. The preamplifier of claim 1 wherein the voltage determining circuit is housed within the preamplifier.

14. The preamplifier of claim 1 wherein the sound gathering device is a transducer.

15. A method of automatically determining which, of a plurality of power sources, to use for powering a preamplifier comprising:
receiving an input voltage from an external power source;
regulating the input voltage to produce a predetermined voltage;
comparing the predetermined voltage with an internal power source voltage; and
powering the preamplifier with the higher voltage.

16. The method of claim 15 wherein the step of comparing comprises:
passing the predetermined voltage through a first diode; and
passing the internal power source voltage through a second diode.

17. The method of claim 16 wherein the step of powering comprising:
turning off the first diode if the internal power source voltage is higher than the predetermined voltage; and
turning off the second diode if the predetermined voltage is higher than the internal power source voltage.

18. A preamplifier for use with a multi-pin conductor cable having a ¼″ stereo plug, the conductor cable connected to an external apparatus at an opposite end, comprising:
an input buffer, for receiving input from at least one sound gathering device;
a mixer amplifier, for mixing signals from the input buffer, for transmission to the external apparatus;
a jack for receiving the stereo plug of the multi-pin cable; and
a voltage circuit for transmitting signals to the multi-pin cable regardless of the pin settings.

19. The preamplifier of claim 18 wherein the voltage circuit includes a capacitor for shunting the circuit.
